(19) United States
(12) Patent Application Publication
(10) Pub. No.: US 2026/0273718 A1
(43) Pub. Date: Sep. 17, 2026

(54) CLEANING DEVICE AND ELECTRICAL POWER TOOL

(71) Applicant: METASEE LLC, AUSTIN, TX (US)

(72) Inventors: Huaqing Chen, Shenzhen (CN); Feng Wang, Shenzhen (CN)

(21) Appl. No.: 19/436,127

(22) Filed: Dec. 30, 2025

(30) Foreign Application Priority Data
Mar. 14, 2025 (CN) 202510305572.9
Mar. 14, 2025 (CN) 202520467535.3

(51) Int. Cl. B25G 1/06; B08B 1/12; B08B 1/36; B25G 3/24; B25G 3/38

(52) U.S. Cl. CPC B25G 1/06; B08B 1/12; B08B 1/36; B25G 3/24; B25G 3/38

(57) ABSTRACT

The application relates to the field of electrical power tools and discloses a cleaning device. The cleaning device includes: a first body having a drive device for outputting torque arranged therein; a second body rotatably connected to the first body, the second body including a rotating part that rotates around a first axis direction; a power transmission device having an input shaft connected to an output end of the drive device and an output shaft connected to the rotating part; and a cleaning component disposed on the rotating part. The relative angle between the second body and the first body is adjustable, allowing the angle of the cleaning component to be adjusted according to actual needs, thereby avoiding a series of defects caused by traditional fixed connection methods.

### TECHNICAL FIELD

The present application relates to the field of electrical power tool, more particularly to a cleaning device and electrical power tool.

### BACKGROUND

Electric cleaning brushes are widely used power tools for daily cleaning, primarily consisting of a handle portion and a cleaning component. The handle portion includes a grip area and control buttons, and is equipped internally with functional modules such as a power system, control circuits, and motor drive mechanism. The cleaning component is fitted with replaceable cleaning attachments that can perform cleaning actions such as rotation or vibration under the drive of the motor mechanism. By installing different cleaning attachments, the brush can be applied to various scenarios including cleaning hard floor surfaces, deep cleaning tile gaps, daily maintenance of bathroom walls, and dust removal from furniture surfaces.

However, traditional electric cleaning brushes employ a fixed connection structure between the handle portion and the cleaning component. This fixed connection design has several drawbacks in use. For example, users need to frequently adjust their arm postures when cleaning surfaces at different positions or angles, which can easily cause fatigue. When cleaning special positions such as wall corners, ceilings, or under furniture, the cleaning brush head with a fixed angle has difficulty conforming to the cleaning surface, resulting in unsatisfactory cleaning effects. Additionally, when users of different heights use the same cleaning brush, differences in operation angles may prevent the cleaning component from achieving optimal working conditions.

### SUMMARY

The cleaning device according to the present application at least partially overcome the deficiencies of traditional electric cleaning brushes.

In the first aspect, embodiments of the present application provide a cleaning device. The cleaning device includes: a first body having a drive device configured to output torque; a second body rotatably connected to the first body, the second body comprising a rotating portion rotatable about a first axis; a power transmission device having an input shaft connected to an output end of the drive device and an output shaft connected to the rotating portion; a cleaning component disposed on the rotating portion and rotating with the rotating portion; wherein a relative angle between the second body and the first body is adjustable.

In the second aspect, embodiments of the present application provide a cleaning device. The cleaning device includes: a first body having a drive device configured to output torque; a second body comprising a rotating portion, the drive device driving the rotating portion to rotate about a first axis; a cleaning component disposed on the rotating portion and rotating with the rotating portion; an angle locking device disposed between the first body and the second body and switchable between a locked state and an unlocked state; wherein the second body is rotatably connected to the first body, and a relative angle between the first body and the second body is adjustable; in the unlocked state, the angle locking device allows change of the relative angle between the first body and the second body; in the locked state, the angle locking device restricts change of the relative angle between the first body and the second body.

In the third aspect, embodiments of the present application provide an electrical power tool. The electrical power tool includes: a first body having a drive device disposed configured to output torque; a second body comprising a rotating portion, the drive device driving the rotating portion to rotate about a first axis; a power transmission device having an input shaft connected to an output end of the drive device and an output shaft connected to the rotating portion; an operational component disposed on the rotating portion and rotating with the rotating portion; wherein a relative angle between the second body and the first body is adjustable, and the power transmission device is a non-coaxial transmission mechanism adapting to the change of the relative angle between the second body and the first body.

At least one advantage of the cleaning device according to the embodiments of the application is: by providing a first body and a second body with adjustable relative angles, the angle of the cleaning component can be adjusted according to actual needs, thereby avoiding a series of deficiencies caused by traditional fixed connection.

### BRIEF DESCRIPTION OF THE DRAWINGS

One or more embodiments are illustrated by way of example in corresponding drawings, which exemplary illustrations do not constitute limitations on the embodiments. Elements denoted by identical reference numerals in the drawings represent similar elements unless specifically stated otherwise, and the drawings are not necessarily drawn to scale.

FIG. 1 is a structural schematic view of a cleaning device according to an embodiment of the present application.

FIG. 2 is a structural schematic view of the cleaning device according to an embodiment of the present application, showing one implementation form of the power transmission device.

FIG. 3 is a structural schematic view of the cleaning device according to another embodiment of the present application, showing another implementation form of the power transmission device.

FIG. 4 is an exploded structural view of the cleaning device according to an embodiment of the present application.

FIG. 5A is a structural schematic view of the cleaning device according to an embodiment of the present application, showing the angle locking device in an unlocked state.

FIG. 5B is a structural schematic view of the cleaning device according to another embodiment of the present application, showing the angle locking device in an unlocked state.

FIG. 6A is a structural schematic view of the cleaning device according to an embodiment of the present application, showing the angle locking device in a locked state.

FIG. 6B is a structural schematic view of the cleaning device according to another embodiment of the present application, showing the angle locking device in a locked state.

FIG. 7 is a sectional view of the angle locking member according to an embodiment of the present application.

FIG. 8 is a state switching diagram of the press-lock member according to an embodiment of the present application.

FIG. 9 is a structural schematic view of the cleaning device according to an embodiment of the present application, showing the first body and second body at approximately 90° angle.

FIG. 10 is a structural schematic view of the cleaning device according to another embodiment of the present application, showing the first body and second body at an obtuse angle.

FIG. 11 is a schematic view of the cleaning component according to embodiments of the present application, showing various different cleaning components.

FIG. 12 is a sectional view of the connecting structure according to an embodiment of the present application.

FIG. 13 is an exploded structural view of the connecting structure according to an embodiment of the present application.

FIG. 14 is a sectional view of the first connecting member according to an embodiment of the present application.

FIG. 15 is a schematic view of the second connecting member according to embodiment of the present application.

FIG. 16 is a schematic view of the second connecting member shown in FIG. 15, showing the state where its top portion is removed.

FIG. 17 is a schematic view of the length adjustment device according to an embodiment of the present application.

FIG. 18 is a functional block diagram of the electronic system of the cleaning device according to an embodiment of the present application.

FIG. 19 is a circuit diagram of the charging-discharging management module according to an embodiment of the present application.

FIG. 20 is a circuit diagram of the charging-discharging management module according to another embodiment of the present application.

FIG. 21 is a circuit diagram of a first signal generating circuit according to an embodiment of the present application.

FIG. 22 is a circuit diagram of a second signal generating circuit according to an embodiment of the present application.

FIG. 23 is a circuit diagram of a third signal generating circuit according to an embodiment of the present application.

FIG. 24 is a circuit diagram of a main control module according to an embodiment of the present application.

FIG. 25 is a circuit diagram of a motor control circuit according to an embodiment of the present application.

FIG. 26 is a circuit diagram of a battery voltage detection circuit according to an embodiment of the present application.

FIG. 27 is a circuit diagram of an insertion wake-up circuit according to an embodiment of the present application.

Reference Numerals: Device body 1, first body 10, first body housing 11, first body connecting portion 12, first connecting recess 121, abutting structure 122; Second body 20, rotating portion 21, second body connecting portion 22, second connecting recess 221, base 23; Power transmission device 30, input shaft 31, output shaft 32, elastic limiting member 33; First input connecting portion 301, first output connecting portion 302, intermediate support portion 303, universal joint structure 304; Second input connecting portion 305, second output connecting portion 306, annular gear disc 307, input bevel gear 308, output bevel gear 309; Cleaning component 40; drive device 50; Angle locking device 60, angle locking member 61, protrusion 62, circular cover 63, press-lock member 64, trigger member 641, clamping member 642, elastic reset member 65; Locking member end face 611, locking member side wall 612, engagement portion 613; First connecting member 71, second connecting member 72, abutting recess 721, locking member 73, abutting member 731, locking elastic member 732, unlocking member 74, press cover 741, engagement member 742, limiting member 743, elastic ejection member 75, ejection cap 751, ejection spring 752; Insertion seat 711, first wall surface 712, second wall surface 713, insertion seat end face 714, insertion seat side wall 715, insertion seat housing 711a, bottom cover 711b; Length adjustment device 80, sleeve 81, inner rod 82, limiting portion 83; Interactive device 90, start button 91, indicator light 92.

### DETAILED DESCRIPTION

The present application will be described in detail below in conjunction with specific embodiments. It should be emphasized that the following description is merely exemplary and is not intended to limit the scope and application of the present application.

Unless otherwise expressly stated and defined, the terms such as "center," "longitudinal," "transverse," "upper," "lower," "vertical," "horizontal," "inner," "outer" and the like used in the present specification to indicate orientations or positional relationships are based on those shown in the drawings. These terms are used solely for convenience of description and simplification of the disclosure, and do not indicate or imply that the referenced device or element must have a particular orientation, be constructed in a particular orientation, or operate in a particular orientation. Therefore, these terms should not be construed as limitations of the present disclosure. Terms such as "mounted," "coupled," "connected," "fixed" and the like should be broadly interpreted. For example, the connection can be a fixed connection, a detachable connection, or an integral connection; the coupling can be a mechanical coupling or an electrical coupling; the connection can be a direct connection or an indirect connection through an intermediate medium.

Furthermore, the terms "first," "second" are used merely for descriptive purposes and should not be construed as indicating or implying relative importance or tacitly indicating the number of technical features being referenced. Thus, features defined as "first" and "second" may explicitly or implicitly include one or more such features. The term "plurality" means two or more. The term "and/or" includes any and all combinations of one or more of the associated listed items. Those skilled in the art can understand the specific meanings of the above terms in the present disclosure according to specific contexts.

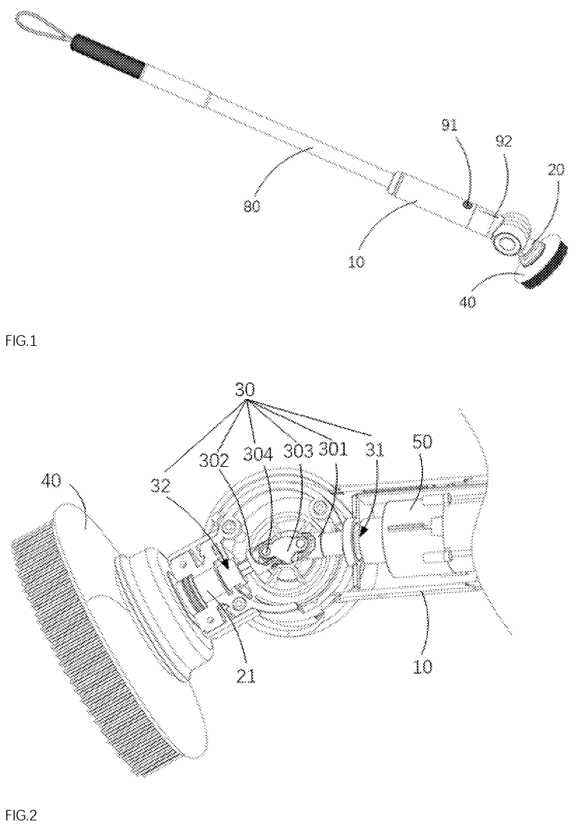

FIG. 1 is a structural schematic view of a cleaning device according to an embodiment of the present disclosure. FIG. 2 shows the cleaning device with partial housing structure removed. As shown in FIGS. 1 and 2, the cleaning device includes: a first body 10, a second body 20, a power transmission device 30, and a cleaning component 40.

The first body 10 serves as the main structure of the cleaning device. It provides one or more mounting positions internally for accommodating various functional modules (for example, a drive device 50 for outputting torque).

The drive device 50 is an operating mechanism that converts stored energy into mechanical motion. It generates and outputs predetermined torque according to control signals to provide the necessary power for the rotation of the cleaning component 40.

According to practical requirements, the drive device 50 may be any suitable type of mechanisms, including motors, reduction gear sets, bearing support structures, and sealing protection structures. One or more components thereof may be omitted or replaced, as long as it meets the usage requirements and provides appropriate torque.

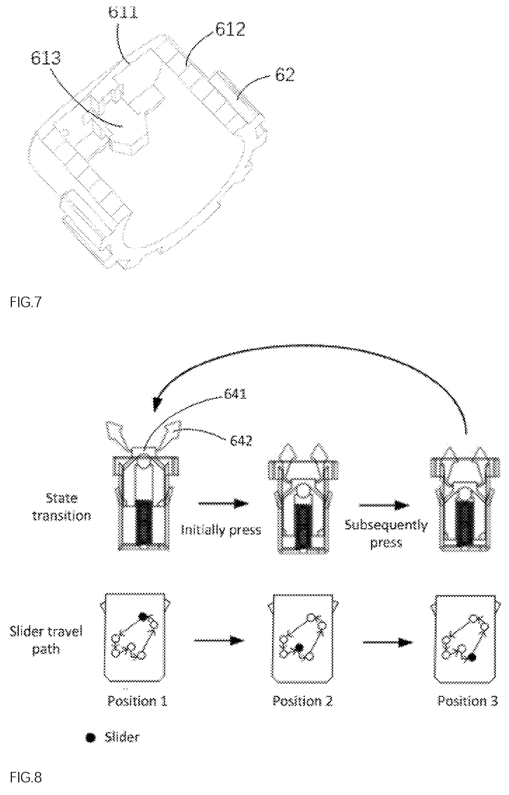

The second body 20 is a structural portion connected to the cleaning component 40. It is rotatably connected to the first body 10 with certain degrees of freedom. As shown in FIGS. 8 and 9, by changing the relative angle between the first body 10 and the second body 20, angle adjustment of the cleaning component 40 can be achieved to adapt to different usage scenarios.

Specifically, as shown in FIG. 2, the second body 20 includes: a rotating portion 21 that rotates about a first axis. The cleaning component 40 is disposed on the rotating portion 21 and rotates with the rotating portion 21 to perform cleaning tasks.

The cleaning component 40 is disposed on the rotating portion 21 using any suitable connection method according to practical application requirements, including but not limited to snap-fit connection and magnetic connection.

The power transmission device 30 is a transmission mechanism for achieving torque transmission between the first body 10 and the second body 20. Its input shaft 31 is connected to the output end of the drive device 50, while its output shaft 32 is connected to the rotating portion 21.

In the present application, the term "non-coaxial transmission mechanism" refers to a transmission device where the input shaft 31 and output shaft 32 can form any angle within a specific angular range, while ensuring stable torque transmission within this range.

By employing a non-coaxial transmission mechanism as the power transmission device 30, it can adapt to the relative angle changes between the second body 20 and the first body 10, maintaining continuous and smooth power transmission even when the relative positions of the input shaft 31 and output shaft 32 change, thereby smoothly driving the rotating portion 21 to rotate and consequently driving the cleaning component 40 to rotate at a predetermined speed.

In some embodiments, as shown in FIG. 4, the first body 10 includes: a first body housing 11 and a first body connecting portion 12. The second body 20 further includes: a second body connecting portion 22.

The first body housing 11 serves as the housing structure of the first body. The drive device 50 is accommodated and fixed within the first body housing 11.

The first body connecting portion 12 is a connecting structure formed at one end of the first body housing 11. It cooperates with the second body connecting portion 22 to establish the rotatable connection between the first body 10 and the second body 20, thereby enabling the second body 20 to rotate relative to the first body 10 about a second axis direction y.

The second body connecting portion 22 further forms a base 23 for supporting the rotating portion 21. The base 23 extends along a first axis direction x for a predetermined length. The rotating portion 21 is disposed at the base 23 of the second body connecting portion 22, and is rotatably connected to the second body connecting portion 22 through bearings or equivalent rotational structures, enabling the rotating portion 21 to rotate about the first axis direction x relative to the entire second body connecting portion 22.

Exemplarily, referring further to FIG. 4, the first body 10 is formed by joining a first component 10a and a second component 10b along a parting surface. Similarly, the second body connecting portion 22 is also formed by joining a third component 22a and a fourth component 22b along a parting surface.

During actual assembly, the rotating portion 21 is first placed between the third component 22a and the fourth component 22b, then the third component 22a and the fourth component 22b are joined along the parting surface of the second body connecting portion 22, forming a substantially cylindrical second body connecting portion 22.

Subsequently, the second body connecting portion 22 is placed between the first component 10a and the second component 10b, at a position corresponding to the first body connecting portion 12. Then, the third component 22a and the fourth component 22b are joined along the parting surface of the first body 10 to form the complete first body 10. At this point, the outer wall surface of the second body connecting portion 22 abuts and cooperates with the inner wall of the first body connecting portion 12, forming a rotatable connection.

It should be noted that the described above assembly process serves only as an exemplary illustration of establishing the rotatable connection between the first body connecting portion 12 and the second body connecting portion 22 and should not be construed as limiting the assembly process. According to practical requirements, any other suitable types of assembly methods or component assembly sequences may be employed.

Specifically, in addition to the aforementioned rotatable connection formed by the mutual abutment between the outer wall surface of the substantially cylindrical second body connecting portion 22 and the inner wall of the first body connecting portion 12, where the second body connecting portion 22 is accommodated within the cylindrical space formed inside the first body connecting portion 12, other types of rotatable connection methods may be selected between the first body connecting portion 12 and the second body connecting portion 22, such as using rotating shafts.

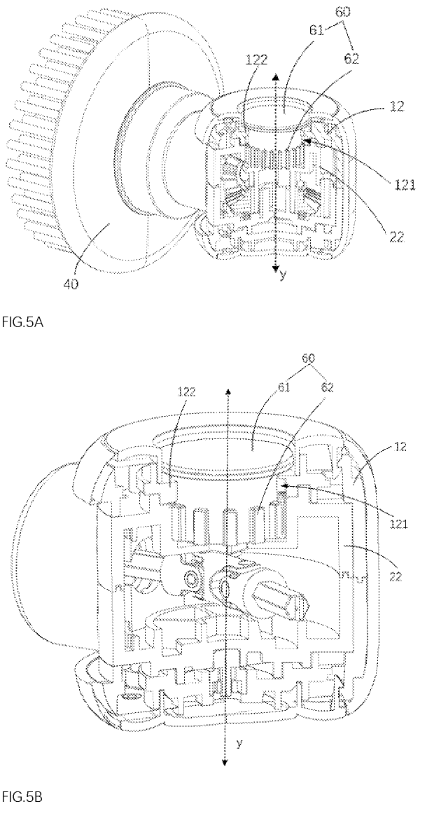

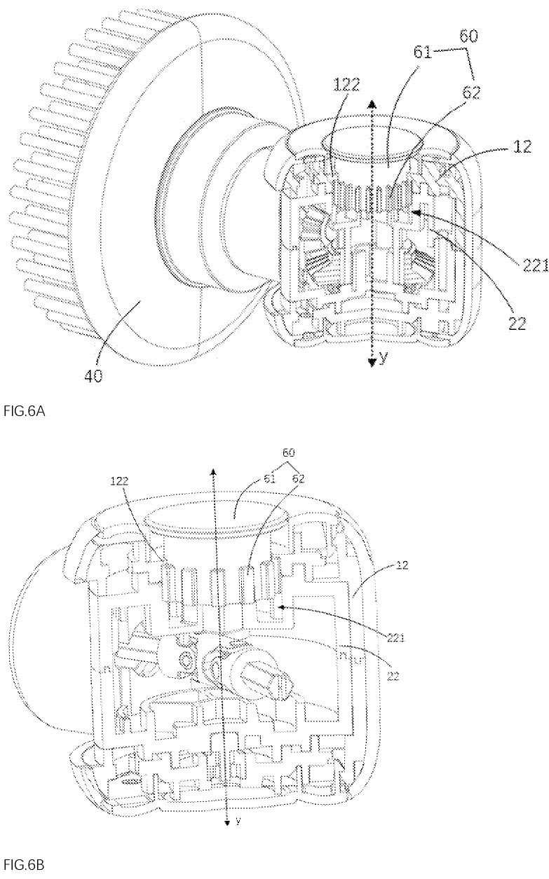

To prevent arbitrary changes in the relative angle between the first body 10 and the second body 20 during use, in some embodiments, as shown in FIGS. 5 and 6, the cleaning device further includes: an angle locking device 60.

The angle locking device 60 is disposed between the first body connecting portion 12 and the second body connecting portion 22, configured to restrict the rotation of the first body connecting portion 12 relative to the second body connecting portion 22 about the second axis direction y.

Specifically, the angle locking device 60 is a movable mechanism capable of switching between a locked state and an unlocked state. It achieves the switching between the locked state and unlocked state by moving to different positions along the second axis direction y.

As shown in FIGS. 5A and 5B, in the unlocked state, the angle locking device 60 moves to an unlocked position along the second axis direction y, disengaging from the first body connecting portion 12. The rotational constraint between the angle locking device 60 and the first body connecting portion 12 is released, allowing the first body connecting portion 12 to rotate relative to the second body connecting portion 22 about the second axis direction y.

As shown in FIGS. 6A and 6B, in the locked state, the angle locking device 60 moves in the reverse direction along the second axis direction y to a locked position. At this point, the angle locking device 60 forms rotational constraints with both the first body connecting portion 12 and the second body connecting portion 22, preventing relative rotation between the first body connecting portion 12 and the second body connecting portion 22.

The specific structure of the angle locking device 60 can be implemented according to practical requirements (for example, the specific method of achieving rotatable connection between the first body connecting portion 12 and the second body connecting portion 22) to fulfill the aforementioned functions required of the angle locking device 60.

The following description is provided in conjunction with one or more embodiments of the angle locking device 60.

In some embodiments, continuing to refer to FIG. 4, along the second axis direction y, a first through hole R1 is formed in the first body connecting portion 12, and a second receiving space R2 is formed in the second body connecting portion 22.

The angle locking device 60, in a form similar to a pin, passes through the first through hole R1 and inserts into the second receiving space R2. Thus, when the angle locking device 60 moves along the second axis direction y toward the second body connecting portion 22 to disengage from the first body connecting portion 12, the rotational constraint with the first body connecting portion 12 is released, entering the unlocked state.

Conversely, when the angle locking device 60 moves along the second axis direction y toward the first body connecting portion 12 to re-establish physical connection with the first body connecting portion 12, the angle locking device 60 can form rotational constraints with both the first body connecting portion 12 and the second body connecting portion 22, switching to the locked state.

The rotational constraint between the angle locking device 60 and the first body connecting portion 12 or the second body connecting portion 22 may be established through various connecting components.

For example, the rotational constraint is formed by the cooperation of multiple protrusions arranged around the second axis direction y and multiple corresponding grooves matching with them. When the protrusions engage with their corresponding grooves, the rotational constraint is formed, and as the protrusions disengage from the grooves, the rotational constraint is released.

For convenience of description, the multiple protrusions are hereinafter referred to as "first connecting element," and the multiple corresponding grooves are referred to as "second connecting element."

Exemplarily, FIGS. 4 to 6 show an arrangement where the first connecting element are provided on the angle locking device, while both the first body connecting portion and the second body connecting portion are provided with the second connecting element.

Alternatively, the arrangement of the first connecting element and the second connecting element can be reversed, with the second connecting element provided on the angle locking device, and the first connecting element provided on the first body connecting portion and the second body connecting portion.

In some embodiments, continuing to refer to FIG. 4, the angle locking device 60 includes: an angle locking member 61, a press-lock member 64, and an elastic reset member 65.

The angle locking member 61 is the main movable component of the entire angle locking device. It can reciprocate along the second axis direction y between an unlocked position and a locked position.

Multiple protrusions 62 are provided on the outer surface of the angle locking member 61 as first connecting element, arranged circumferentially around the second axis direction y.

Correspondingly, multiple first connecting recesses 121 are provided on the first body connecting portion 12 as second connecting element, and multiple second connecting recesses 221 are provided on the second body connecting portion 22 as second connecting element.

When the angle locking member 61 moves to the locked position, the protrusions 62 simultaneously engage with both the first connecting recesses 121 and the second connecting recesses 221, preventing relative rotation between the first body 10 and the second body 20 due to the restriction of the angle locking member 61, and the angle locking device 60 is in the locked state (as shown in FIG. 6A).

When the angle locking member 61 moves to the unlocked position, the protrusions 62 disengage from the first connecting recesses 121 and only remain engaged with the second connecting recesses 221 (as shown in FIG. 5A), allowing relative rotation between the first body 10 and the second body 20, and the angle locking device 60 is in the unlocked state.

Specifically, at least a portion of the angle locking member 61 is located on the outer surface of the cleaning device, allowing users to apply operation to drive the angle locking device 60 to move along the second axis direction y.

Based on practical usage requirements, the structure of the angle locking member 61 located on the outer surface of the cleaning device can have any suitable shape or size. For example, as shown in FIG. 4, a circular cover 63 is located on the surface of the cleaning device.

The press-lock member 64 is a structural component used to achieve automatic state locking of the angle locking device 60. It has press-to-unlock characteristics and includes at least one trigger member 641 and clamping member 642. When the trigger member 641 is pressed for the first time, the clamping member 642 switches to and maintains a clamping state, and when the trigger member 641 is pressed again, the clamping member 642 exits the clamping state and switches to a release state.

Exemplarily, FIG. 8 shows a state switching diagram of a typical press-lock member 64. As shown in FIG. 8, the press-lock member 64 is provided with a guide track that guides a slider to travel along a predetermined path. The slider is connected to the trigger member 641 through a connecting member, having a linkage relationship. The connecting member is also rotatably connected to the clamping member 642, allowing the clamping member 642 to switch between clamping state and release state as the slider's position changes.

When the trigger member 641 is initially pressed, it drives the slider to move downward from the starting position 1 along the slider travel path through the connecting member. Subsequently, under the action of spring, the slider is retained at position 2. At this time, the clamping member 642 is in the clamping state.

When the trigger member 641 is subsequently pressed, it drives the slider past position 2 to position 3. Subsequently, under the action of the spring, it returns to position 1 along the slider travel path. At this time, the clamping member 642 returns to the release state.

Based on the same principle as the press-lock member 64 shown in FIG. 8, other different types of press-lock members 64 can be used, not limited to what is shown in FIG. 8. Specific adjustments and substitutions are well known to those skilled in the art and are not specifically limited herein.

The elastic reset member 65 is an elastic structure (for example, a compression spring) disposed within the angle locking member 61. It is configured to elastically deform and store elastic potential energy during the position changes of the angle locking member 61. When external force is removed, the elastic reset member 65 tends to return to its initial state, thereby driving the angle locking member 61 to reset to the locked position.

In some embodiments, as shown in FIG. 4, the press-lock member 64 is fixed at a locking installation position Set on the second body connecting portion 22. In the unlocked state, the protrusions 62 of the angle locking member 61 are only positioned within the second connecting recesses 221.

Alternatively, the press-lock member 64 can be provided on the first body connecting portion 12. Correspondingly, in the unlocked state, the protrusions 62 of the angle locking member 61 are only positioned within the first connecting recesses 121.

During actual use, when a user applies operation to the angle locking member 61 (for example, applying pressing operation to the circular cover 63), the angle locking member 61 moves along the second axis direction y to the unlocked position, where the protrusions 62 disengage from the first connecting recesses 121 and are only positioned within the second connecting recesses 221. Meanwhile, the angle locking member 61 also applies the first press to the press-lock member 64, causing the press-lock member 64 to engage with the angle locking member 61, maintaining the angle locking member 61 in the unlocked position.

When the user continues to apply operation to the angle locking member 61 (for example, continuing to press the circular cover 63), the angle locking member 61 its displacement to subsequently pressing the press-lock member 64 again. The press-lock member 64 then transitions to the release state, thereby no longer constraining the movement of the angle locking member 61.

As the press-lock member 64 releases the angle locking member 61, the tendency of the elastic reset member 65 to return to its initial state pushes the angle locking member 61 back to the locked position, where the protrusions 62 re-enter the first connecting recesses 121, switching the angle locking device 60 to the locked state.

In some embodiments, as shown in FIGS. 4 and 6, the first body connecting portion 12 is also provided with an abutting structure 122. When the angle locking member 61 is driven by the elastic reset member 65 to reset to the locked position, the abutting structure 122 abuts against at least a portion of the angle locking member 61, enabling the angle locking member 61 to maintain in the locked position without disengaging from the first body connecting portion 12.

Exemplarily, the abutting structure 122 is a protrusion platform set at the top of the first connecting recess. When the angle locking member 61 moves to the locked position, it abuts against the protrusions 62, limiting the angle locking member 61 from further outward movement.

In some embodiments, when applying the press-lock member 64 as shown in FIG. 8, as shown in FIG. 7, the angle locking member 61 includes: a locking member end face 611, a locking member side wall 612, and an engagement portion 613.

The locking member side wall 612 extends a specific length along the rotation axis direction y from the peripheral edge of the locking member end face 611. The locking member side wall 612 and the locking member end face 611 together define the internal space of the angle locking member 61.

The engagement portion 613 is a structure that works in cooperation with the press-lock member 64. It is provided on the locking member end face 611, located within the internal space enclosed by the locking member side wall 612.

It can be understood that based on different specific installation positions of the press-lock member 64, the engagement portion 613 can have corresponding matching positions to cooperate with the press-lock member 64, achieving control over the position of the angle locking member 61, not limited to what is shown in FIG. 7.

During practical application, when the angle locking member 61 moves with the angle unlocking member (for example, circular cover 63), the top of the engagement portion 613 presses the trigger member 641 of the press-lock member 64, at which time the clamping member 642 of the press-lock member 64 clamps and fixes the engagement portion 613, maintaining the position of the angle locking member 61, allowing the angle locking device to maintain in the unlocked state.

When the angle locking member 61 further moves with the angle unlocking member (for example, circular cover 63), the top of the engagement portion 613 continues to press the trigger member 641 of the press-lock member 64. At this time, the clamping member 642 of the press-lock member 64 releases the engagement portion 613, disengaging the connection with the engagement portion 613. Under the action of the elastic reset member 65, the angle locking member 61 resets to the initial position where the protrusions 62 partially enter the first connecting recesses 121, and the angle locking device switches back to the locked state.

In some embodiments, by appropriately setting the extending direction of the connecting recesses and protrusions, guiding function can also be provided to guide the angle locking member 61 to move along the rotation axis y.

Continuing to refer to FIG. 5A and FIG. 6A, the first connecting recesses 121 and second connecting recesses 221 are grooves extending along the rotation axis y, having substantially identical widths. The protrusions 62 disposed on the surface of the angle locking member 61 are dimensioned and configured to mate with either the second connecting recesses 221 or the first connecting recesses 121.

Thus, the first connecting recesses 121 and second connecting recesses 221 can serve as guide grooves, cooperating with the protrusions 62 inserted therein to guide the angle locking member 61 to move along the second axis direction y.

There are several different structural embodiments of the non-coaxial transmission mechanism. In some embodiments, as shown in FIG. 2, the power transmission device 30 includes: a first input connecting portion 301, a first output connecting portion 302, and an intermediate support portion 303.

Among these, one end of the first input connecting portion 301 forms an input shaft 31, which connects to the output end of the drive device. One end of the first output connecting portion 302 forms an output shaft 32, which connects to the rotating portion 21. The two ends of the intermediate support portion 303 are rotatably connected to the first input connecting portion 301 and the first output connecting portion 302 respectively through two universal joint structures 304.

Thus, the two universal joint structures 304 form two rotation axes with different angles through the intermediate support portion 303, which can accommodate angular deflection between the input shaft 31 and output shaft 32.

When the relative angle between the first body 10 and second body 20 changes, the torque output from the drive device 50 can still be transmitted to the rotating portion 21, driving the cleaning component 40 to rotate.

The power transmission device 30 shown in FIG. 2 has a certain degree of freedom of movement. When the drive device 50 of the cleaning device is not activated and in a stationary state, The power transmission device 30 may easily undergo some irregular movements following changes in the cleaning device's position, producing collision sounds.

In some embodiments, to limit the irregular movement of the power transmission device 30 in the stationary state and avoid unwanted noise, as shown in FIG. 12, the power transmission device also includes: an elastic limiting member 33.

The elastic limiting member 33 is an elastic component configured to store elastic potential energy and return to its initial state. One end of the elastic limiting member 33 is secured to the rotating portion 21, while the other end of the elastic limiting member 33 is secured to the first output connecting portion 302, thereby applying a retaining force to maintain the position of the power transmission device 30 and prevent unintended movement.

Specifically, the elastic limiting member 33 is a spring in a stretched state. The rotating portion 21 provides a mounting pin H1 as a fixed mounting position, and the end of the first output connecting portion 302 forms a fixing hole H2. The spring in the stretched state has one end hooked onto the mounting pin H1 and the other end hooked onto the fixing hole H2, thereby pulling the power transmission device 30 toward the rotating portion 21.

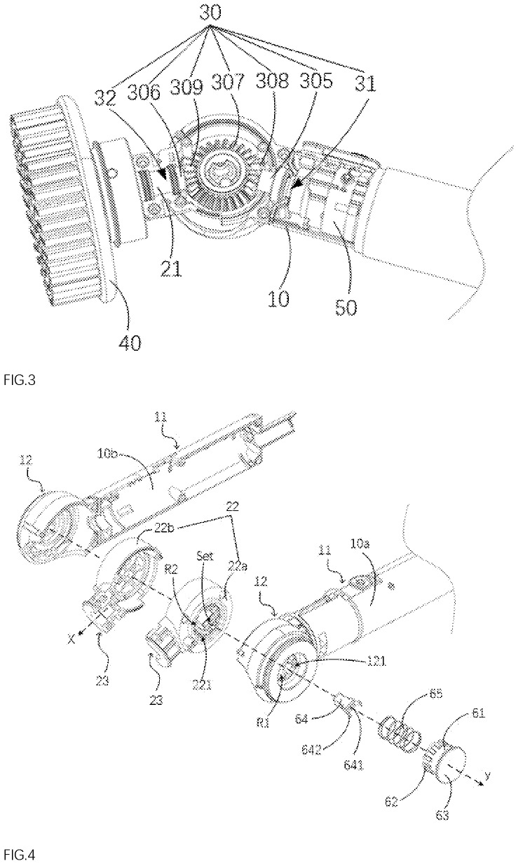

In other embodiments, the non-coaxial transmission mechanism can also be implemented through gear engagement. As shown in FIG. 3, the power transmission device 30 includes: a second input connecting portion 305, a second output connecting portion 306, and an annular gear disc 307.

Among these, one end of the second input connecting portion 305 forms an input shaft 31, which connects to the torque output end of the drive device. The other end of the second input connecting portion 305 is an input bevel gear 308. One end of the second output connecting portion 306 forms an output shaft 32, and the other end of the second output connecting portion 306 is provided with an output bevel gear 309. The annular gear disc 307 is arranged perpendicular to the rotation axis. Both the input bevel gear 308 and output bevel gear 309 engage with the annular gear disc 307.

Thus, the engagement between the annular gear disc 307 and the input bevel gear 308, and the engagement between the annular gear disc 307 and the output bevel gear 309, respectively form two rotation axes. Even when the angle between these two rotation axes changes, torque can still be transmitted through the annular gear disc 307, thereby accommodating angular deflection between the input shaft 31 and output shaft 32.

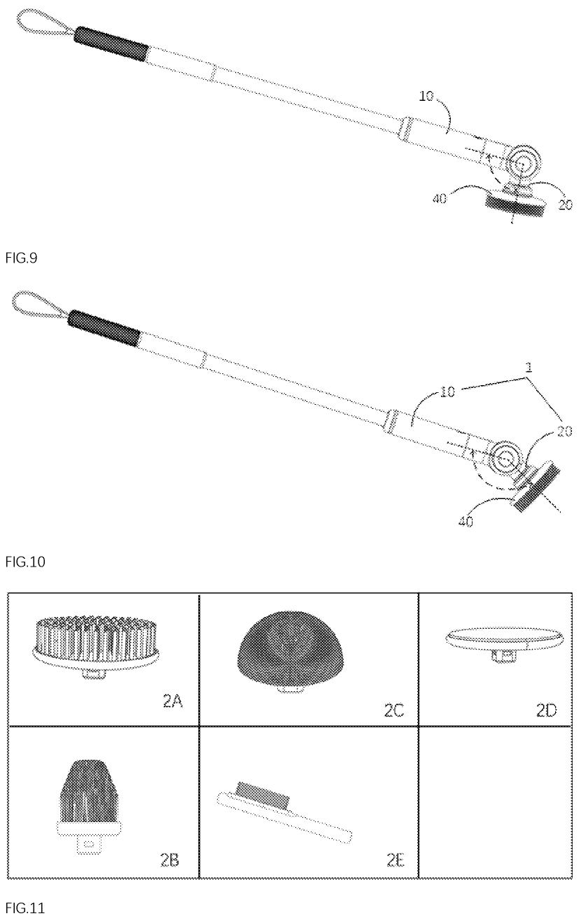

The following description, in conjunction with FIG. 9 and FIG. 10, details the process of relative angle change between the first body 10 and second body 20 of the cleaning device. As shown in FIG. 9, the relative angle between the first body 10 and second body 20 is approximately 90°. At this time, the cleaning brush surface of the cleaning component 40 is substantially parallel to the handle-shaped first body 10, allowing users to conveniently grip the first body 10 and clean against vertical wall surfaces.

When floor cleaning is needed, as shown in FIG. 10, users can change the relative angle between the first body 10 and second body 20 to be greater than 90°. At this time, the cleaning brush surface of the cleaning component 40 forms a certain angle with the handle-shaped first body 10, allowing users to conveniently grip the first body 10 and clean against the floor surface.

To meet the practical needs of different cleaning scenarios, the cleaning device is equipped with various cleaning components for users to choose from. For example, as shown in FIG. 11, the cleaning components include: a flat brush head 2A suitable for cleaning large flat surfaces; a conical corner brush 2B specifically designed for cleaning hard-to-reach areas such as crevices; a dome-shaped brush 2C designed for cleaning irregular surfaces or curved objects; a cleaning pad mount 2D serving as a universal base for installing various cleaning pads; and a dusting brush 2E with fine needle-like bristles suitable for cleaning precision equipment (such as keyboards, electronic devices).

Users can select one of these cleaning components according to their needs, secure it to the rotating portion 21 of the device body 1, and perform cleaning operations. In the application, the device body 1 refers to the structural assembly composed of all components except the cleaning component, such as the first body 10 and second body 20.

When the actual usage scenario changes, the cleaning component 40 also needs to be replaced accordingly. In some embodiments, by providing a connection structure between the cleaning component 40 and the device body 1 that enables quick disassembly and assembly, the user experience can be effectively enhanced.

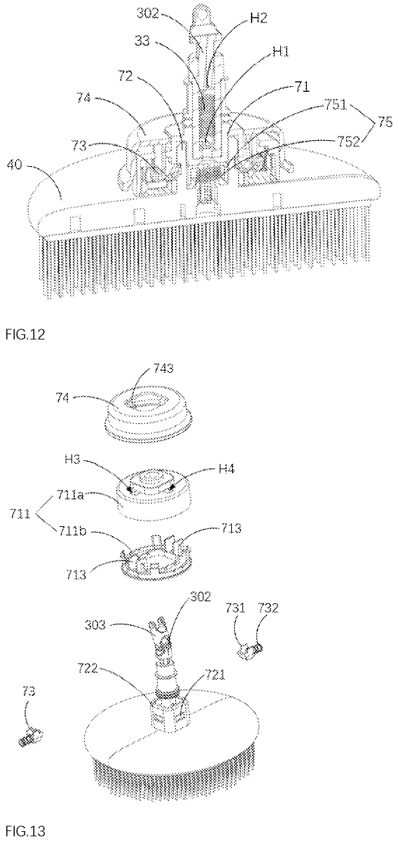

As shown in FIG. 12 and FIG. 14, the connection structure includes: a first connecting member 71, a second connecting member 72, a locking member 73, and an unlocking member 74.

The first connecting member 71 defines a locking space R3. The second connecting member 72 has a matching size and shape and is accommodated within the locking space R3.

The locking member 73 is a component that protrudes into the locking space R3 in its default state. In the application, the "default state" refers to the state of the locking member 73 when no external force is applied.

The protruding locking member 73 abuts against the second connecting member 72 that has entered the locking space R3, preventing the second connecting member 72 from disengaging from the locking space R3, restricting the separation of the second connecting member 72 from the first connecting member 71, thus achieving reliable fixed connection between the two.

The unlocking member 74 is a component that engages with the locking member 73. It can drive the locking member 73 to withdraw from the locking space R3, causing the locking member 73 to no longer abut against the second connecting member 72. Specifically, at least a portion of the unlocking member 74 is located on the outer surface of the cleaning device for user operation convenience.

When the user applies an unlocking operation (for example, a pressing operation) to the unlocking member 74, driving the unlocking member 74 to move, it correspondingly drives the locking member 73 to withdraw from the locking space R3. As the locking member 73 withdraws from the locking space R3, the second connecting member 72 can smoothly disengage from the locking space R3, releasing its fixed connection with the first connecting member 71.

Based on the aforementioned assembly method between the first connecting member 71 and the second connecting member 72, after respectively installing the first connecting member 71 and the second connecting member 72 on the device body 1 and the cleaning component 40, quick disassembly and assembly of the cleaning component 40 can be achieved using the first connecting member 71 and the second connecting member 72.

For ease of description, the embodiments of the application describe the scenario where the first connecting member 71 is provided on the device body 1 and the second connecting member 72 is provided on the cleaning component 40. Alternatively, interchanging the positions of the first connecting member 71 and the second connecting member 72 (i.e., arranging the first connecting member 71 on the cleaning component and the second connecting member 72 on the device body) can achieve the same quick disassembly and assembly effect.

In some embodiments, referring further to FIG. 12, the connection structure 70 further includes: an elastic ejection member 75.

The elastic ejection member 75 is an elastic component capable of storing elastic potential energy through deformation. When the second connecting member 72 is accommodated in the locking space R3, the elastic ejection member 75 is maintained in a deformed state with a tendency to return to its initial state.

When the second connecting member 72 is released from the constraint of the locking member 73, the elastic ejection member 75 returns to its initial state, thereby applying an ejection force to separate the first connecting member 71 from the second connecting member 72, enabling automatic ejection of the cleaning component 40.

Specifically, referring further to FIG. 12, the elastic ejection member 75 includes: an ejection cap 751 and an ejection spring 752.

The ejection cap 751 is movably mounted on the second connecting member 72. The ejection spring 752 is positioned between the ejection cap 751 and the second connecting member 72.

When the second connecting member 72 is inserted and accommodated in the locking space R3, the first connecting member 71 abuts against the ejection cap 751, compressing the ejection cap 751 and causing the ejection spring 752 to be in a compressed state.

As the locking member 73 releases its lock on the second connecting member 72, the compressed ejection spring 752 returns to its initial state, applying force to the first connecting member 71 through the ejection cap 751, automatically pushing the second connecting member 72 away from the first connecting member 71.

It should be noted that FIG. 12 illustratively shows the elastic ejection member 75 arranged on the second connecting member 72. Based on the cooperative relationship between the first connecting member 71 and second connecting member 72, arranging the elastic ejection member 75 on the first connecting member 71 can achieve the same effect of automatically ejecting the cleaning component 40.

In some embodiments, a length adjustment device 80 is also provided in the device body 1, which serves as a handle portion for users to grip, allowing the length of the device body to be adjusted within a certain range to meet different usage needs.

As shown in FIG. 17, the length adjustment device 80 includes: a first portion 10c, a second portion 10d, a sleeve 81, and an inner rod 82.

The inner wall of the sleeve 81 is provided with internal threads and is fixedly installed in the first portion 10c. The surface of the inner rod 82 is provided with external threads and is fixedly installed in the second portion 10d. The inner rod 82 and sleeve 81 are connected through thread engagement.

Thus, when users rotate the second portion 10d, it can drive the inner rod 82 to undergo axial displacement relative to the sleeve 81, causing the second portion 10d to move away from or toward the first portion 10c, achieving adjustment of the overall length of the first body 10.

This thread-based length adjustment method ensures stable positioning of the second portion 10d after length adjustment.

Specifically, a protruding limiting portion 83 is also provided at the end of the inner rod 82. When the inner rod 82 rotates to its limit position, this limiting portion 83 abuts against the end of the sleeve 81, preventing the inner rod 82 from disengaging from the sleeve 81.

In some embodiments, referring further to FIG. 1, the length adjustment device 80 is an extension assembly independently arranged relative to the first body 10. The length adjustment device 80 is fixed to the end of the first body 10 through plug-in fixing or other suitable fixed connection methods to provide greater rod length.

The following description details the specific structural implementation of the first connecting member 71, second connecting member 72, locking member 73, and unlocking member 74 in conjunction with the drawings.

In some embodiments, as shown in FIG. 14, the first connecting member 71 includes: an insertion seat 711, a first wall surface 712, and a second wall surface 713.

The insertion seat 711 is a columnar structure formed by an insertion seat end face 714 and an insertion seat side wall 715. The insertion seat side wall 715 extends to a specific length along the peripheral edge of the insertion seat end face 714. Illustratively, the insertion seat 711 is substantially cylindrical.

The first wall surface 712 is a continuous wall surface provided on the insertion seat end face 714. It cooperates with the insertion seat end face 714 to form the locking space R3 for accommodating the second connecting member 72. An opening R4 is formed in the first wall surface 712 for the locking member 73 to protrude through.

The second wall surface 713 is another wall surface arranged between the first wall surface 712 and the insertion seat side wall 715. It forms a guide channel matching with the locking member 73. The locking member 73 is arranged in the guide channel, moving along the extension direction of the guide channel, protruding into the locking space R3 through the opening R4, or withdrawing from the locking space R3.

Specifically, as shown in FIG. 13, the insertion seat 711 includes an insertion seat housing 711a and a bottom cover 711b. The bottom cover 711b is engaged with the opening end of the insertion seat housing 711a through snap-fit or other fixed connection methods to form a complete insertion seat 711.

In some embodiments, referring further to FIG. 12 and FIG. 13, the locking member 73 includes: an abutting member 731 and a locking elastic member 732.

The abutting member 731 is disposed within the guide channel and is dimensioned to match the width of the guide channel. The abutting member 731 is configured to travel along the guide channel to enter or exit the locking space R3 through the opening R4.

For ease of description, the position where the abutting member 731 protrudes into the locking space R3 is referred to as the "first position," while the position where the abutting member 731 completely withdraws from the locking space R3 is referred to as the "second position."

The locking elastic member 732 is also an elastic component. It connects with the abutting member 731 and deforms to store elastic potential energy when the abutting member 731 leaves the first position due to external force.

For example, the locking elastic member 732 is a compression spring that tends to return to its uncompressed initial state and can generate elastic force to drive the abutting member 731 to move toward the first position.

In some embodiments, a first squeezing contact surface is formed between the abutting member 731 and the end of the second connecting member 72, causing the abutting member 731 to move to the second position under compression from the second connecting member 72.

In the application, "squeezing contact surface" refers to a contact surface between two components where at least a portion of the contact surface is inclined relative to the insertion direction of one of the components. Such a squeezing contact surface can convert at least a portion of the force pushing one component into a force driving the other component to move perpendicular to the insertion direction.

For example, the portion of the abutting member 731 protruding into the locking space is wedge-shaped, and correspondingly, the end 722 of the second connecting member 72 is set as an inclined surface. As the second connecting member 72 is inserted, the abutting member 741 forms an inclined first squeezing contact surface with the end 722 of the second connecting member 72 and withdraws from the locking space R3 under compression from the second connecting member 72.

In some embodiments, referring further to FIG. 13, an abutting recess 721 is provided on the surface of the second connecting member 72. The specific size and depth of the abutting recess 721 can be set according to actual needs and are not specifically limited herein.

Thus, when the second connecting member 72 moves to a position where the abutting recess 721 corresponds to the opening R4, the abutting member 731 automatically returns to the first position, urged by the locking elastic member 732, protruding into the locking space R3.

A first abutting contact surface is formed between the protruding abutting member 731 and the abutting recess 721, restricting the second connecting member 72 from disengaging from the locking space R3.

In the application, "abutting contact surface" refers to a contact surface formed between two components that establishes an abutting relationship, where one component restricts the movement of the other component in a specific direction.

In some embodiments, to provide balanced locking force and ensure reliable connection between the cleaning component and the device body, as shown in FIG. 13, the locking member 73 is arranged in pairs (for example, two locking members) symmetrically along a first direction or a second direction. This symmetrical arrangement enables the locking member 73 to provide symmetric forces to restrict the second connecting member 72 from disengaging from the locking space R3.

In other embodiments, as shown in FIG. 15, the second connecting member 72 includes a first surface S1, a second surface S2, a third surface S3, and a fourth surface S4.

The first surface S1 and third surface S3 are symmetrical surfaces along the first direction K1, while the second surface S2 and fourth surface S4 are symmetrical surfaces along the second direction K2.

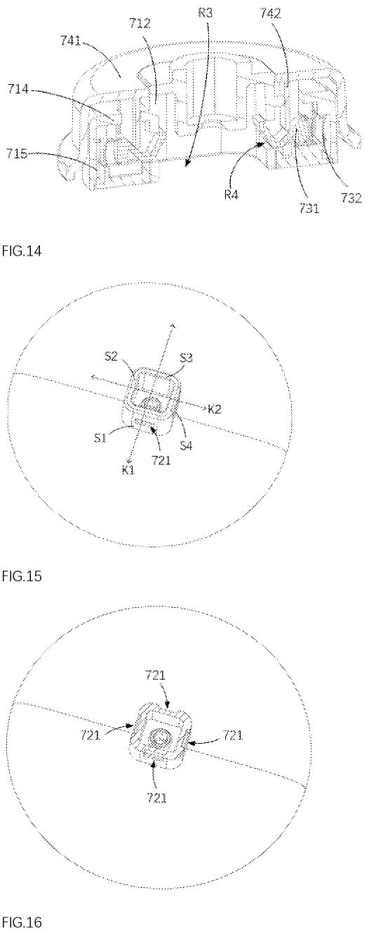

As shown in FIG. 16, abutting recesses 721 are provided on all of the first surface S1, second surface S2, third surface S3, and fourth surface S4, so that when the second connecting member 72 is inserted into the locking space R3 in two different directions, the locking member 73 can form an abutting contact surface with the recess 731.

In some embodiments, referring further to FIG. 13 and FIG. 14, the unlocking member 74 includes: a press cover 741 and an engagement member 742.

The press cover 741 covers the exterior of the insertion seat 711 and is a component that can move along the first axis direction x. The engagement member 742 is arranged inside the press cover 741.

Correspondingly, a first hole H3 is formed in the insertion seat end face 714 of the insertion seat 711. The engagement member 742 passes through the insertion seat 711 via the first hole H3 and forms a second squeezing contact surface with the abutting member 731.

Through the second squeezing contact surface formed between the engagement member 742 and the abutting member 731, there exists a linkage relationship between the press cover 741 and the abutting member 731.

To facilitate describing the linkage relationship between the press cover 741 and the abutting member 731, a third position is used to indicate the position of the press cover 741 when the abutting member 731 automatically returns to the first position, and a fourth position is used to indicate the position of the press cover 741 when the abutting member 731 is pushed to the second position.

To ensure the press cover 741 does not disengage from the insertion seat 711, in some embodiments, referring further to FIG. 13, the unlocking member 74 also includes: a limiting member 743. Correspondingly, a second hole H4 is also formed in the insertion seat end face 714.

The limiting member 743 is also a structural component arranged inside the press cover 741. It is arranged at a different position from the engagement member 742 and passes through the insertion seat end face 714 via the second hole H4.

The end of the limiting member 743 has a relatively enlarged protruding portion that is at least larger than the second hole H4. Thus, when the press cover 741 moves to the fourth position, the enlarged portion at the end of the limiting member 743 forms a second abutting contact surface with the insertion seat end face 714, preventing further movement of the press cover 741.

For example, the end of the limiting member 743 forms a hook structure, and a corresponding recess matching the hook structure is provided at the corresponding position of the insertion seat end face 714, forming a second abutting contact surface between them.

In some embodiments, one or more interactive devices 90 can also be provided on the cleaning device to help users understand the current operating status of the cleaning device and output corresponding operation instructions.

Referring further to FIG. 1, the interactive device includes: a start button 91 and several indicator lights 92.

The start button 91 is used to receive user operation instructions to control the start and stop of the cleaning device. The indicator lights 92 indicate device status such as power on, running, fault, or power off through different display states (such as steady on, flashing, or off).

Through the start button, users can conveniently control the device's working status, while through different display states of the indicator lights, the device's current operating conditions can be intuitively reflected, enabling users to make timely operational adjustments.

In other embodiments, the interactive device may also include a display. The display is an interactive device capable of showing information such as the cleaning device's working mode, operation time, battery level, and speed settings in the form of visual information, allowing users to more comprehensively understand the operating status of the cleaning device.

Furthermore, the display can work in conjunction with the electronic system to show fault codes or fault prompt information when device abnormalities occur, helping users quickly identify problems. Additionally, the display can show device maintenance reminder information, such as cleaning component replacement cycles and maintenance schedules, facilitating user routine maintenance and care.

In some embodiments, the cleaning device uses a motor as a power source and contains a battery pack for storing electrical energy in the device body, converting the electrical energy stored in the battery pack into mechanical energy through the motor to drive the cleaning component rotation.

Specifically, the battery pack used in the cleaning device can be composed of multiple rechargeable batteries in series/parallel or series-parallel hybrid configuration. Correspondingly, the device body is also equipped with a charging interface that can connect to an external power source for charging the battery pack.

Based on the inventive concept of the cleaning device provided in the above one or more embodiments, the cleaning component 40 of the cleaning device can be further replaced with operational component of other types of electrical power tools without changing the structural design, thereby extending the application of this cleaning device's inventive concept to various electrical power tools with rotating functions, achieving the same technical effects as in the above one or more embodiments.

For example, in electrical power tools such as electric sanders, electric polishers, electric mixers, electric pruning tools, and electric screwdrivers, by providing a first body, second body, non-coaxial power transmission device, and an operational component disposed on the rotating portion, efficient power transmission from the drive device to the executing mechanism can be achieved while maintaining stable and reliable power output at different angles through the variable angle structure between the first body and second body, combined with the non-coaxial transmission mechanism, improving operational flexibility and ease of use.

FIG. 18 is a functional block diagram of the electronic system of the cleaning device provided by embodiments of the application. As shown in FIG. 18, the electronic system of the cleaning device includes: a battery pack 910, a charging module 920, a charging and discharging management module 930, a main control module 940, and a motor 950.

The charging module 920 is a functional circuit that works with the charging interface. When the charging interface is connected to an external power source (for example, when a power adapter is plugged in), it provides a first voltage from the charging interface to the charging and discharging management module 930.

According to practical needs, the charging interface can be any suitable type of interface and provide a specific first voltage. For example, the charging interface can be a Type-C interface, providing a first voltage with a value of 5V.

The charging and discharging management module 930 is a functional circuit used to monitor the operating status of the battery pack 910, control the discharge of the battery pack 910, and charge the battery pack 910. It has voltage conversion capability and can convert the first voltage to a suitable charging voltage for charging the battery pack 910 when the charging interface is connected to an external power source.

Additionally, by monitoring one or more status parameters of the battery pack 910 during charging and discharging, the charging and discharging management module 930 can also provide one or more protection functions such as overcharge protection and temperature protection, ensuring the safe operation of the battery pack 910.

The main control module 940 is the control core of the cleaning device. It can collect operation instructions input by users through the aforementioned one or more interactive devices and control the cleaning device to execute corresponding operations (for example, controlling the motor 950 to start or stop running). It can also detect and collect the operating status of the motor 950, control the aforementioned one or more interactive devices to display and provide feedback about the current status information of the cleaning device to users (for example, the remaining battery capacity, motor operating status), and provide one or more protection functions such as motor short circuit protection, motor operating temperature protection, and battery pack discharge protection.

Between the main control module 940 and the charging and discharging management module 930, in addition to the power connection line 941 for power transmission, signal connection lines are also provided for information transmission to achieve communication between the two functional circuits.

Specifically, the signal connection lines include: a wake-up signal connection line 942 and a status detection connection line 943. The wake-up signal connection line 942 is used to transmit detection signals indicating whether an external power source is connected to the charging interface. The status detection connection line 943 is used to transmit detection signals indicating whether the battery pack is in a charging state.

When an external power source is connected to the charging interface (for example, when a power adapter is plugged in), the charging and discharging management module 930 can generate corresponding insertion detection signals and transmit them to the main control module 940 through the wake-up signal connection line 942.

The charging and discharging management module 930 can also generate different status detection signals based on whether the battery pack is currently in a charging or discharging state and transmit them to the main control module 940 through the status detection connection line 943, enabling the main control module 940 to identify and determine the current state of the battery pack 910.

To fully describe the inventive concept of the application, the specific circuit implementation of the charging and discharging management module 930 and the main control module 940 will be described in detail with reference to FIGS. 19 to 27. As an example, the charging interface is a Type-C interface, and the battery pack 910 consists of three lithium-ion batteries connected in series.

FIG. 19 is a circuit schematic diagram showing how the charging and discharging management module 930 implements voltage conversion functionality. As shown in FIG. 19, the circuit components of the charging and discharging management module 930 for implementing voltage conversion include: first resistor R1, second resistor R2, transient voltage suppressor diode TVS, first capacitor C1, second capacitor C2, third capacitor C3, fourth capacitor C4, fifth capacitor C5, sixth capacitor C6, first inductor L1, third resistor R3, fourth resistor R4, fifth resistor R5, sixth resistor R6, seventh resistor R7, and a boost charging management circuit U1.

J1 represents the charging interface. Pins 2 and 5 are VBUS pins, used to provide 5V voltage. Pins 3 and 4 are CC1 and CC2 configuration pins respectively, used for Type-C protocol configuration, and pins 1 and 6 are GND pins.

One end of the first resistor R1 is grounded, and the other end is connected to pin 3 of the charging interface J1. One end of the second resistor R2 is grounded, and the other end is connected to pin 4 of the charging interface J1.

The negative terminal of the transient voltage suppressor diode TVS is connected to pin 2, and its positive terminal is connected to pin 6 of the charging interface J1, providing electrostatic protection and overvoltage protection functions to prevent sudden high voltage from entering and damaging the subsequent circuits.

Pin 2 and pin 5 of the charging interface J1 are connected to form a power supply node VIN. When a power adapter is plugged into the charging interface, the power supply node VIN provides 5V voltage.

The boost charging management circuit U1 includes 8 pins, labeled as pins 1 through 8. Pin 1 is the system voltage output terminal, used to provide a stable second voltage (for example, 3.3V or 5V) for the electronic system, pin 2 is the boost output terminal that can output boosted charging voltage (for example, 12.6V), pin 3 is the charging voltage setting terminal that adjusts the boost output charging voltage through connection to a resistor with specific resistance value, pin 4 is the temperature detection terminal, pin 5 is the charging indication output terminal used to drive indicator lights to display current charging status, pin 6 is the voltage input terminal, pin 7 is the boost switch drive terminal, and pin 8 is the switching node.

One end of the first capacitor C1 is grounded, and the other end is connected to the power supply node VIN. One end of the first inductor L1 is connected to the power supply node VIN, and the other end is connected to pin 8 of the boost charging management circuit U1.

One end of the second capacitor C2 is connected to pin 8 of the boost charging management circuit U1, and the other end is connected to pin 7 of the boost charging management circuit U1. One end of the third capacitor C3 is grounded, and the other end is connected to pin 6 of the boost charging management circuit U1.

One end of the third resistor R3 is connected to the power supply node VIN, and the other end is grounded. One end of the fourth resistor R4 is connected to the power supply node VIN, and the other end is connected to pin 6 of the boost charging management circuit U1.

One end of the fifth resistor R5 is connected to pin 5 of the boost charging management circuit U1, and the other end is connected to the first charging status detection terminal CHG_DET1.

One end of the fourth capacitor C4 is grounded, and the other end is connected to pin 1 of the boost charging management circuit U1. One end of the fifth capacitor C5 is grounded, and the other end is also connected to pin 1 of the boost charging management circuit U1.

Pin 2 of the boost charging management circuit U1 is connected to the positive terminal B+ of the battery pack. Pin 3 of the boost charging management circuit U1 is grounded through the sixth resistor R6, and pin 4 is grounded through the seventh resistor R7. One end of the sixth capacitor C6 is connected to the positive terminal B+ of the battery pack, and the other end is grounded.

During actual operation, the internal MOS switch of the boost charging management circuit U1 connects to the first inductor L1 and second capacitor C2 through pins 8 and 7, collectively forming a boost circuit to perform voltage boost conversion on the input voltage (i.e., the first voltage from power supply node VIN) received at pin 6. The boosted second voltage is output from pin 2 of the boost charging management circuit U1 to charge the battery pack.

Pin 4 of the boost charging management circuit U1 monitors the current temperature of the battery pack. Charging stops when the charging temperature of the battery 100 is abnormal. Pin 5 of the boost charging management circuit U1 outputs different indication signals based on the current charging status (for example, outputs a high-level signal during charging, and outputs a low-level signal when not charging).

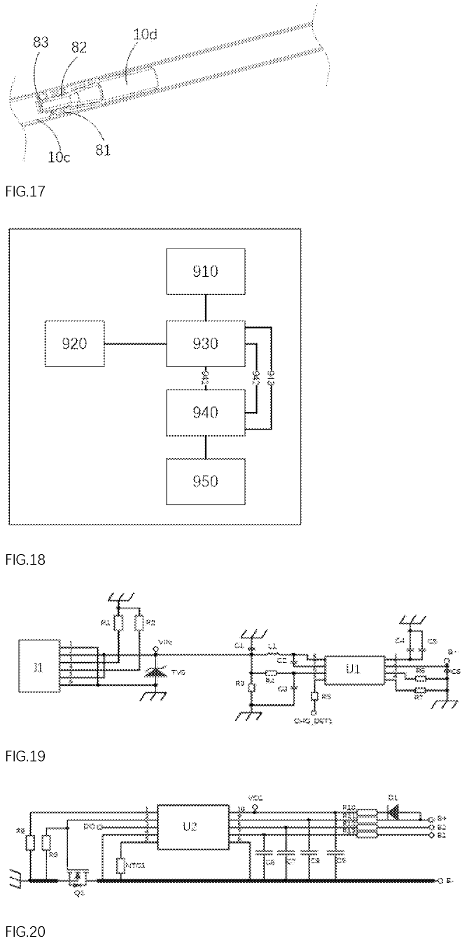

FIG. 20 is a circuit schematic diagram of the charging and discharging management module 930 implementing battery detection and protection functions. As shown in FIG. 20, the circuit for battery detection and protection functions includes: a battery protection chip U2, a charging control MOS transistor Q1, eighth resistor R8, ninth resistor R9, thermistor NTC1, tenth resistor R10, eleventh resistor R11, twelfth resistor R12, thirteenth resistor R13, first diode D1, seventh capacitor C7, eighth capacitor C8, ninth capacitor C9, and tenth capacitor C10.

The battery protection chip U2 includes 10 pins, labeled as pins 1 through 10. Pin 1 is used to detect the total voltage of the battery pack, pin 2 is used to control the conduction and cutoff of the first MOS transistor Q1. Pin 3 is used to output discharge indication signals. Pin 4 is the power input terminal. Pin 5 is the temperature detection terminal, pin 6 is the circuit reference ground connection terminal, pins 7 to 9 are voltage detection terminals for individual battery cells, used to detect the voltages of three lithium-ion batteries in the battery pack. Pin 10 is the power supply terminal, connected to the DC voltage source VCC.

The gate of the first MOS transistor Q1 is connected to pin 2 of the battery protection chip U2, the source of Q1 is connected to the reference ground, and the drain of Q1 is connected to the negative terminal B- of the battery pack.

Pin 1 of the battery protection chip U2 is connected to the negative terminal B- of the battery pack through the eighth resistor R8. Pin 2 of the battery protection chip U2 is also connected to the negative terminal B- of the battery pack through the eleventh resistor R11.

One end of the first thermistor NTC1 is connected to the negative terminal B- of the battery pack, and the other end is connected to pin 5 of the battery protection chip U2.

Pin 6 of the battery protection chip U2 is connected to the reference ground. Pin 7 of U2 is connected to the reference ground through the seventh capacitor C7. Pin 8 of U2 is connected to the reference ground through the eighth capacitor C8. Pin 9 of U2 is connected to the reference ground through the ninth capacitor C9. Pin 10 of U2 is connected to the reference ground through the tenth capacitor C10.

The negative terminal of the first diode D1 is connected to the positive terminal B+ of the battery pack, and its positive terminal is connected to pin 10 of the battery protection chip U2 through the tenth resistor R10.

Pin 9 of the battery protection chip U2 is connected to the positive terminal B+ of the battery pack through the eleventh resistor R11. The positive terminal B2 of the second lithium-ion battery is connected to pin 8 of U2 through the twelfth resistor R12, and the positive terminal B1 of the third lithium-ion battery is connected to pin 7 of U2 through the thirteenth resistor R13.

Thus, the battery protection chip U2 can detect both the total voltage of the battery pack and the voltage of each lithium-ion battery. When battery voltage becomes too high or too low, it controls the first MOS transistor Q1 to disconnect.

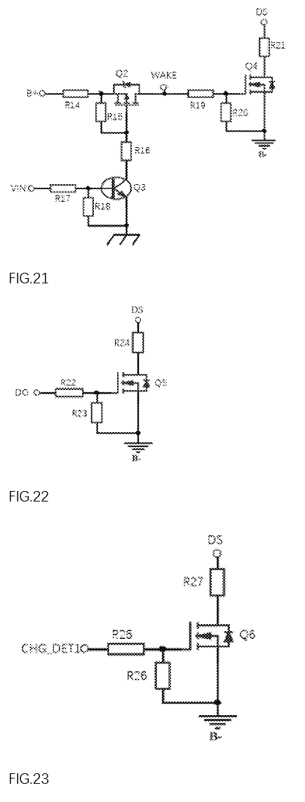

FIG. 21, FIG. 22 and FIG. 23 are circuit schematic diagrams of the charging and discharging management module 930 generating detection signals. For ease of description, three relatively independent detection signal generation circuits are referred to as the "first signal generation circuit," "second signal generation circuit," and "third signal generation circuit."

As shown in FIG. 21, the first signal generation circuit includes: second MOS transistor Q2, third MOS transistor Q4, first bipolar transistor Q3, fourteenth resistor R14, fifteenth resistor R15, sixteenth resistor R16, seventeenth resistor R17, eighteenth resistor R18, nineteenth resistor R19, twentieth resistor R20, and twenty-first resistor R21.

The drain of the second MOS transistor Q2 is connected to the positive terminal B+ of the battery pack through the fourteenth resistor R14. The gate of Q2 is connected to its drain through the fifteenth resistor R15. The gate of Q2 is connected to the collector of the first bipolar transistor Q3 through the sixteenth resistor R16.

The emitter of the first bipolar transistor Q3 is grounded, and its base is connected to the power supply node VIN through the seventeenth resistor R17. The base of Q3 is also connected to its emitter through the eighteenth resistor R18.

The gate of the third MOS transistor Q4 is connected to the source of Q2 through the nineteenth resistor R19, with the wake signal terminal WAKE located between R19 and the source of Q2.

The drain of the third MOS transistor Q4 is connected to the detection signal terminal DS through the twenty-first resistor R21. The gate of Q4 is also connected to its source through the twentieth resistor R20. The source of Q4 is connected to the negative terminal B- of the battery pack.

During practical application, when the power adapter is inserted, the power supply node VIN generates a high-level signal, controlling the first bipolar transistor Q3 to conduct. When Q3 conducts, it pulls down the gate voltage of Q2, causing Q2 to conduct as well.

When Q2 conducts, the wake signal terminal WAKE generates a high-level signal and transmits it to the main control module 930 through the signal connection line, allowing the main control module 930 to detect that the power adapter has been inserted.

Additionally, when Q2 conducts, Q4 will also conduct, pulling down the level signal at the detection signal terminal DS. The low-level signal at DS can also be transmitted to the main control module 930 through the signal connection line, indicating that the battery pack is in charging state.

As shown in FIG. 22, the second signal generation circuit includes: fourth MOS transistor Q5, twenty-second resistor R22, twenty-third resistor R23, and twenty-fourth resistor R24.

The source of the fourth MOS transistor Q5 is connected to the negative terminal B- of the battery pack, its gate is connected to pin 3 of the battery protection chip U2 through the twenty-second resistor R22. The gate of Q5 is also connected to its source through the twenty-third resistor R23. The drain of Q5 is connected to the detection signal terminal DS through the twenty-fourth resistor R24.

When the battery pack is in charging state, pin 3 of the battery protection chip U2 outputs a high-level signal. At this time, Q5 conducts, also pulling down the level signal at the detection signal terminal DS, indicating that the battery pack is in charging state.

As shown in FIG. 23, the third signal generation circuit includes: fifth MOS transistor Q6, twenty-fifth resistor R25, twenty-sixth resistor R26, and twenty-seventh resistor R27.

The source of the fifth MOS transistor Q6 is connected to the negative terminal B- of the battery pack, its gate is connected to one end of the twenty-fifth resistor R25. The other end of R25 forms the first charging status detection terminal CHG_DET1, connected to pin 5 of the boost charging management circuit U1. The gate of Q6 is also connected to its source through the twenty-sixth resistor R26. The drain of Q6 is connected to the detection signal terminal DS through the twenty-seventh resistor R27.

When the battery pack is in charging state, pin 5 of the boost charging management circuit U1 outputs a high-level signal. At this time, Q6 conducts, similarly pulling down the level signal at the detection signal terminal DS, indicating that the battery pack is in charging state.

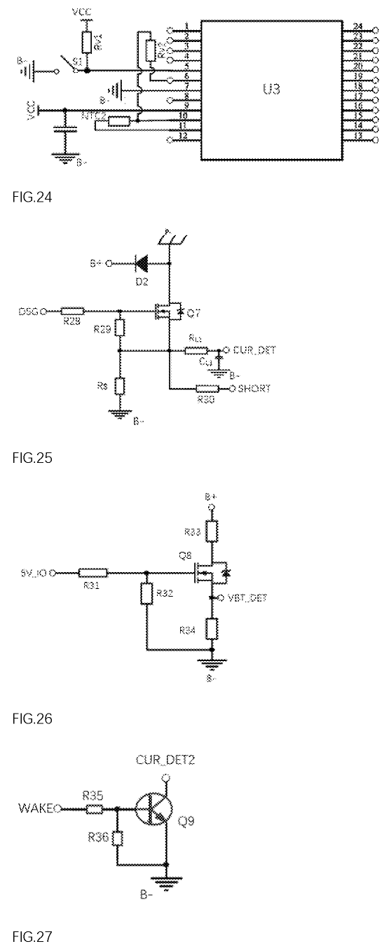

FIGS. 24 to 27 are circuit schematic diagrams of the main control module provided in the application. It includes a main control chip U3 and several cooperating peripheral circuits.

As shown in FIG. 24, the main control chip U3 includes 24 pins, labeled as pins 1 through 24. Pin 1 is the charging status detection terminal, pins 2 and 3 are both status indication terminals. Pin 4 is the reset input terminal, used to receive external reset signals. Pin 5 is the switch detection terminal. Pin 6 is the detection signal receiving terminal. Pin 7 is connected to the negative terminal B- of the battery pack. Pin 8 is the data communication terminal. Pin 9 is the power terminal, connected to the stable second voltage VCC, which supplies power to the main control chip U3. Pin 10 is the voltage output terminal, capable of outputting specific DC voltage (for example, 5V) when the main control chip U3 powers on or changes state. Pin 11 is the temperature detection input terminal, used to detect motor temperature. Pin 12 is the battery voltage detection input terminal. Pin 13 is the short circuit detection input terminal. Pin 14 is the motor current detection input terminal, used to detect the motor's operating current. Pins 15, 16, 17, and 18 are all independent status indication terminals. Pin 19 is the discharge control terminal, used to control battery discharge. Pins 20 and 21 are status indication terminals. Pin 22 is the data communication clock terminal. Pins 23 and 24 are also status indication terminals.

Based on the functions to be executed by the main control chip U3, the pin functions and corresponding peripheral circuits are described as follows:

1) Cleaning device startup and status display:

As shown in FIG. 24, one end of the startup switch S1 is connected to the negative terminal B- of the battery pack, and the other end is connected to pin 5 of the main control chip U3. Pin 5 of U3 is also connected to the DC voltage VCC through the first pull-up resistor Rv1. Pin 17 of U3 is connected to the first LED indicator group.

In the power-off state, startup switch S1 is open, and the level signal of pin 5 of U3 is pulled high by the first pull-up resistor. When the user performs a power-on startup operation (e.g., touching or pressing the power button), startup switch S1 closes, pulling down the level signal of pin 5 of U3, allowing the main control chip U3 to detect the power-on startup operation.

Depending on the current operating state, pin 17 of U3 outputs high or low-level status indication signals to control the illumination or extinction of the first LED indicator group, thereby displaying the current operating state of the cleaning device to the user.

2) Battery pack power level display:

The cleaning device's surface has sequentially arranged second LED indicator, third LED group, fourth LED group, fifth LED group, sixth LED group, seventh LED group, and eighth LED group.

Pins 18, 19, 21, 23, 24, 2, and 3 of U3 are respectively connected to the second LED indicator, third LED group, fourth LED group, fifth LED group, sixth LED group, seventh LED group, and eighth LED group.

Based on the received remaining battery power information, pins 18, 19, 21, 23, 24, 2, and 3 of U3 independently control each LED group, displaying the current battery power level to the user by adjusting the number of illuminated LED groups.

3) Motor status detection and control:

As shown in FIG. 24, pin 10 of U3 outputs DC voltage (e.g., 5V) after power-on. The second thermistor NTC2 is positioned near the motor, with its two ends connected to pins 10 and 11 of U3.

The motor's operating temperature changes the resistance value of NTC2, causing voltage changes at pin 11 of U3. Thus, the main control chip U3 achieves motor temperature detection and executes motor temperature protection function (stopping motor operation when temperature is too high).

As shown in FIG. 25, the motor control circuit includes: sixth MOS transistor Q7, twenty-eighth resistor R28, twenty-ninth resistor R29, thirtieth resistor R30, second diode D2, sampling resistor Rs, and filter components resistor R_{L1} and capacitor C_{L1}.

The drain of Q7 is connected to motor P- and to the positive terminal B+ of the battery pack through D2. The gate of Q7 is connected to the motor control terminal DSG through R28.

The gate of Q7 is also connected to its source through R29. The source of Q7 is connected to the negative terminal B- of the battery pack through Rs. One end of R_{L1} is connected to the source of Q7, the other end is connected to the current sampling terminal CUR_DET, and R_{L1} is also connected to B- through C_{L1}. One end of R30 is connected to the source of Q7, the other end forms the short circuit detection terminal SHORT.

Pin 19 of U3 is connected to the motor control terminal DSG. When pin 19 outputs a high-level signal, it controls Q7 to conduct, powering the motor, and when it outputs a low-level signal, Q7 cuts off, stopping motor operation by disconnecting power.

Pin 14 of U3 is connected to the current sampling terminal CUR_DET. The sampling resistor Rs generates a voltage signal proportional to the motor current. The voltage signal produced by Rs is processed through the filter and output from CUR_DET to U3. Based on the voltage signal received at pin 14, U3 can calculate and determine the motor's operating current.

Pin 13 of U3 is connected to the short circuit detection terminal SHORT. When a short circuit occurs in the motor, the current through Rs rapidly increases, producing a sudden rise in voltage signal at SHORT. U3 determines whether a short circuit has occurred based on whether pin 13 receives a sudden voltage signal change.

When U3 determines a short circuit has occurred, it triggers protection action by outputting a low-level signal through pin 19, cutting off power to stop motor operation.

4) Battery pack voltage detection:

As shown in FIG. 26, the battery voltage detection circuit includes: seventh MOS transistor Q8, thirty-first resistor R31, thirty-second resistor R32, thirty-third resistor R33, and thirty-fourth resistor R34.

The gate of Q8 is connected to the power-on detection terminal 5V_IO through R31. The gate of Q8 is also connected to the negative terminal B- of the battery pack through R32.

The source of Q8 is connected to B- through R34. The drain of Q8 is connected to the positive terminal B+ of the battery pack through R33. The connection point between the source of Q8 and R34 forms the battery voltage detection terminal VBT_DET.

Pin 10 of U3 is connected to 5V_IO. Pin 12 of U3 is connected to VBT_DET.

When U3 powers on, pin 10 outputs DC voltage. At this time, Q8 conducts, and U3 obtains the battery pack voltage through pin 12.

5) Power adapter insertion detection and charging status detection:

As shown in FIG. 25, pin 6 of U3 is connected to signal line 943 to receive charging status detection signals. Pin 6 of U3 is also connected to pin 10 through the second pull-up resistor RV2.

Through the second pull-up resistor RV2, this ensures stable voltage level at pin 6 of U3, enabling reliable reception of detection signals from signal line 943 (i.e., level signals provided by detection signal terminal DS).

As shown in FIG. 27, the insertion wake-up circuit includes: second transistor Q9, thirty-fifth resistor R35, and thirty-sixth resistor R36.

The base of Q9 is connected to the wake-up signal terminal WAKE through R35 and also connected to its emitter through R36. The emitter of Q9 is also connected to B-. The collector of Q9 forms the second charging detection terminal CHG_DET2. This CHG_DET2 is connected to pin 1 of U3.

When the power adapter is inserted into the charging port, the wake-up signal terminal WAKE of the charge-discharge management module 920 forms a high-level signal, which is transmitted through signal line 942 to the wake-up signal terminal WAKE of the main control module 930, pulling up the base voltage level of Q9.

At this time, Q9 conducts, pulling down the level signal at CHG_DET2. When the main control chip U3 detects that pin 1's level is pulled low, it wakes up and enters charging state for charging the battery pack.

6) Motor operation mode display:

To meet different cleaning scenario requirements, the motor of the cleaning device has two different operating modes (for example, high-speed mode and low-speed mode). Pins 15 and 16 of U3 can be respectively connected to two LED mode indicators, displaying the current motor operating mode by controlling the illumination/extinction of these two LED mode indicators.

In the present application, the correlations and relationships between different embodiments are recorded and described in detail. Based on these recorded correlations and relationships, those skilled in the art can understand and confirm whether technical features involved in different embodiments conflict with each other.

Furthermore, when technical features involved in different embodiments are not explicitly recorded and described as conflicting with each other in the correlations and relationships, they can be combined to obtain more embodiments. These embodiments obtained through simple combinations all fall within the scope of disclosure of the application.

The above content provides further detailed description of the application in conjunction with specific/preferred embodiments, but the specific implementation of the application should not be limited to these descriptions. For those skilled in the art, various modifications and improvements can be made without departing from the concept of the application, and all these modifications and improvements fall within the scope of protection of the application.

1. A cleaning device, comprising:
a first body having a drive device configured to output torque;
a second body rotatably connected to the first body, the second body comprising a rotating portion rotatable about a first axis;
a power transmission device having an input shaft connected to an output end of the drive device and an output shaft connected to the rotating portion;
a cleaning component disposed on the rotating portion and rotating with the rotating portion;
wherein a relative angle between the second body and the first body is adjustable.

2. The cleaning device according to claim 1, wherein the first body comprises:
a first body housing accommodating and fixing the drive device;
a first body connecting portion formed at one end of the first body housing;
wherein the second body further comprises:
a second body connecting portion rotatably connected to the first body connecting portion;
wherein the rotating portion is rotatably connected to the second body connecting portion and rotatable about the first axis relative to the second body connecting portion.

3. The cleaning device according to claim 2, wherein the cleaning device further comprises:
an angle locking device disposed between the first body connecting portion and the second body connecting portion, configured to restrict rotation of the first body connecting portion relative to the second body connecting portion about a second axis.

4. The cleaning device according to claim 3, wherein the angle locking device is movable along the second axis between a locked state and an unlocked state;
in the locked state, the angle locking device simultaneously forms rotational constraints with both the first body connecting portion and the second body connecting portion, whereby preventing rotation about the second axis;
in the unlocked state, the angle locking device releases the rotational constraint with either the first body connecting portion or the second body connecting portion, whereby allowing rotation about the second axis.

5. The cleaning device according to claim 4, wherein the rotational constraint is formed by cooperation between a first connecting element and a second connecting element;
the first connecting element comprises multiple protrusions arranged circumferentially around the second axis, and the second connecting element comprises multiple grooves mating with the protrusions; the protrusions engage with the grooves, whereby the rotational constraint is formed;
wherein either:
the first connecting element is disposed on the angle locking device, and both the first body connecting portion and second body connecting portion are provided with the second connecting element; or
the second connecting element is disposed on the angle locking device, and both the first body connecting portion and second body connecting portion are provided with the first connecting element.

6. The cleaning device according to claim 5, wherein the grooves and protrusions extend along the second axis to guide movement of the angle locking device along the second axis.

7. The cleaning device according to claim 5, wherein the angle locking device comprises:
an angle locking member moveable reciprocally between an unlocked position and a locked position along the second axis;
a press-lock member fixed to the second body connecting portion and engaging with the angle locking member in the unlocked position, whereby the angle locking member is maintained in the unlocked position;
an elastic reset member connected to the angle locking member and biasing the angle locking member away from the unlocked position;
wherein when the angle locking member is in the unlocked position, whereby the rotational constraint with the first body connecting portion is released;
wherein when the angle locking member is in the locked position, whereby rotational constraints are simultaneously formed with both the first body connecting portion and the second body connecting portion.

8. The cleaning device according to claim 7, wherein the first body connecting portion is provided with an abutting structure;
wherein when the angle locking member is biased by the elastic reset member to the locked position, at least a portion of the angle locking member abuts against the abutting structure whereby the angle locking member is maintain in the locked position.

9. The cleaning device according to claim 7, wherein the angle locking member comprises:
a locking member end face;
a locking member side wall extending from a peripheral edge of the locking member end face along the rotation axis;
an engagement portion disposed on the locking member end face within an internal space formed by the locking member side wall;
wherein when the angle locking member moves to a first target position, the engagement portion initially presses the press-lock member, whereby the press-lock member maintains engagement with the engagement portion;
wherein when the angle locking member moves to a second target position, the engagement portion subsequently presses the press-lock member, whereby the press-lock member disengages from the engagement portion.

10. The cleaning device according to claim 1, wherein the power transmission device comprises:
a first input connecting portion having one end forming the input shaft;
a first output connecting portion having one end forming the output shaft;
an intermediate support portion having two ends respectively connected to the first input connecting portion and the first output connecting portion through two universal joint structures;
wherein the two universal joint structures form two different rotation axes at different angles through the intermediate support portion to accommodate angular deviation between the input shaft and the output shaft; and
the angular deviation between the input shaft and output shaft varies with the relative angle between the second body and the first body.

11. The cleaning device according to claim 1, wherein the power transmission device further comprises an elastic limiting member;
wherein one end of the elastic limiting member is connected to the rotating portion and another end is connected to the output shaft.

12. The cleaning device according to claim 1, wherein the power transmission device comprises:
a second input connecting portion having one end connected to the drive device and another end formed as an input bevel gear;
a second output connecting portion having one end connected to the rotating portion and another end formed as an output bevel gear;
an annular gear disc meshing with both the input bevel gear and the output bevel gear to form two different rotation axes.

13. The cleaning device according to claim 1, wherein the cleaning device further comprises a connecting structure, wherein the cleaning component is detachably connected to the rotating portion through the connecting structure.

14. The cleaning device according to claim 13, wherein the connecting structure comprises:
a first connecting member forming a locking space;
a second connecting member accommodated within the locking space;
a locking member protruding into the locking space and abutting against the second connecting member, whereby the second connecting member is retained within the locking space;
an unlocking member engaged with the locking member, and, in response to an unlocking operation applied thereto, driving the locking member to withdraw from the locking space.

15. The cleaning device according to claim 14, wherein the connecting structure further comprises:
an elastic ejection member disposed on either the first connecting member or the second connecting member, wherein the elastic ejection member tends to return to its initial state when the second connecting member is accommodated in the locking space;
wherein either:
the first connecting member is disposed on the cleaning component and the second connecting member is disposed on the rotating portion; or
the first connecting member is disposed on the rotating portion and the second connecting member is disposed on the cleaning component.

16. The cleaning device according to claim 14, wherein the first connecting member comprises:
an insertion seat including an insertion seat end face and insertion seat side walls extending along the peripheral edge of the insertion seat end face;
a first wall surface disposed on the insertion seat end face and cooperating with the insertion seat end face to form the locking space, the first wall surface having an opening for the locking member to extend through;
a second wall surface disposed between the first wall surface and the insertion seat side wall to form a guide channel, wherein the locking member is disposed in and movable along the guide channel;
wherein the locking member comprises:
an abutting component disposed in the guide channel and movable between a first position and a second position through the opening;
a locking elastic member connected to the abutting component and tending to return to its initial state when the abutting component moves away from the first position;
wherein the first position is where the abutting component protrudes into the locking space, and the second position is where the abutting component withdraws from the locking space.

17. The cleaning device according to claim 16, wherein the surface of the second connecting member has an abutting recess;
wherein the abutting component and the second connecting member form a first pressing contact surface, causing the abutting component to move to the second position under pressure from the second connecting member;
when the second connecting member moves to a position where the abutting recess aligns with the opening, the abutting component returns to the first position and forms a first abutting contact surface with the abutting recess.

18. The cleaning device according to claim 1, wherein the first body further comprises a length adjustment device configured to adjust the total length of the first body;
wherein the length adjustment device comprises:
a first portion;
a second portion;
a sleeve connected to the first portion;
an inner rod connected to the second portion;
wherein the sleeve and the inner rod are connected through threads, such that rotation of the second portion is converted into axial displacement of the inner rod relative to the sleeve, driving the second portion to move away from or toward the first portion.

19. A cleaning device, comprising:
a first body having a drive device configured to output torque;
a second body comprising a rotating portion, the drive device driving the rotating portion to rotate about a first axis;
a cleaning component disposed on the rotating portion and rotating with the rotating portion;
an angle locking device disposed between the first body and the second body and switchable between a locked state and an unlocked state;
wherein the second body is rotatably connected to the first body, and a relative angle between the first body and the second body is adjustable;
in the unlocked state, the angle locking device allows change of the relative angle between the first body and the second body;
in the locked state, the angle locking device restricts change of the relative angle between the first body and the second body.

20. An electrical power tool, comprising:
a first body having a drive device disposed configured to output torque;
a second body comprising a rotating portion, the drive device driving the rotating portion to rotate about a first axis;
a power transmission device having an input shaft connected to an output end of the drive device and an output shaft connected to the rotating portion;
an operational component disposed on the rotating portion and rotating with the rotating portion;
wherein a relative angle between the second body and the first body is adjustable, and the power transmission device is a non-coaxial transmission mechanism adapting to the change of the relative angle between the second body and the first body.
